(19) United States
(12) Patent Application Publication
(10) Pub. No.: US 2025/0084113 A1
(43) Pub. Date: Mar. 13, 2025

(54) NITROSYL PRECURSORS AND RELATED METHODS

(71) Applicant: ENTEGRIS, INC., Billerica, MA (US)

(72) Inventors: David M. Ermert, Danbury, CT (US); Philip S.H. Chen, Bethel, CT (US)

(21) Appl. No.: 18/825,833

(22) Filed: Sep. 5, 2024

Related U.S. Application Data
(60) Provisional application No. 63/537,502, filed on Sep. 10, 2023.

(51) Int. Cl. C07F 11/00

(52) U.S. Cl. CPC C07F 11/005

(57) ABSTRACT

Precursor compositions and related methods are provided. A precursor composition comprises a precursor compound of the formula: [(L¹)ₙM(L²)ₘ₋ₙ]_{z}, where: L¹ is a first ligand; M is a metal; L² is a second ligand; n is 1 to 6; m is an oxidation state of M; and z is 1 or 2. A purity of the precursor compound in the composition is at least 99.5%. Methods for forming films and methods for making precursor compositions are provided.

### CROSS-REFERENCE TO RELATED APPLICATIONS

This application claims the benefit under 35 USC 119 of U.S. Provisional Patent Application No. 63/537,502, filed Sep. 10, 2023, the disclosure of which is hereby incorporated herein by reference in its entirety.

### FIELD

The present disclosure relates to nitrosyl precursors and related methods.

### BACKGROUND

Some precursors are useful in the manufacture of microelectronic devices. The manufacture of such devices can involve use of precursors to form thin films.

### SUMMARY

Some embodiments relate to a precursor composition. In some embodiments, the precursor composition comprises a compound of the formula:

[(L¹)ₙM(L²)ₘ₋ₙ]_{z},
where:
L¹ is a first ligand;
M is a metal;
L² is a second ligand;
n is 1 to 6;
m is an oxidation state of M; and
z is 1 or 2;
wherein a purity of the precursor compound in the composition is at least 99.5%.

Some embodiments relate to a method for forming a film. In some embodiments, the method comprises one or more of the following steps: obtaining a precursor, obtaining at least one co-reactant precursor, vaporizing the precursor to obtain a vaporized precursor, vaporizing the at least one co-reactant precursor to obtain at least one vaporized co-reactant precursor, contacting at least one of the vaporized precursor, the at least one vaporized co-reactant precursor, or any combination thereof with a substrate, under vapor deposition conditions, to form a film on the substrate.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method for making a film, according to some embodiments.

FIG. 2 is a schematic diagram illustrating a reaction scheme for preparing a precursor composition, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “metal” refers to at least one of an alkali metal, an alkaline earth metal, a transition metal, a post-transition metal, a lanthanoid, an actinoid, or any combination thereof. In some embodiments, for example, the metal comprises or is selected from the group consisting of a transition metal. In some embodiments, the transition metal comprises or is selected from the group consisting of at least one of scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), or any combination thereof. In some embodiments, the metal is in ionic form, elemental form, or any combination thereof.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkoxy” refers to a functional group of formula —OR^{a}, wherein Ra is an alkyl, as defined herein. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As used herein, the terms “amine” and “amino” refer to a functional group of formula —N(R^{b}R^{c}R^{d}), wherein each of R^{b}, R^{c}, and R^{d} is independently a hydrogen or an alkyl, as defined herein. In some embodiments, the amine may comprise a primary amine, a secondary amine, a tertiary amine, or a quaternary amine. In some embodiments, the amine may comprise an alkyl amine, a dialkylamine, or a trialkyl amine. In some embodiments, the amine may comprise, consist of, or consist essentially of, or may be selected from the group consisting of, at least one of methyl amine, dimethylamine, ethylamine, diethylamine, isopropylamine, di-isopropylamine, butylamine, sec-butylamine, tert-butylamine, di-sec-butylamine, isobutylamine, di-isobutylamine, di-tert-pentylamine, ethylmethylamine, isopropyl-n-propylamine, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; and secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine. In some embodiments, the amine is —N(CH₃)₂.

As used herein, the term “halide” refers to a —Cl, —Br, —I, or —F.

As used herein, the term “carbonyl” refers to —C(═O)— or —C(H)(═O).

As used herein, the term “nitrosyl” refers to −N(═O).

As used herein, the term “film” refers to a metal-containing film. In some embodiments, the metal-containing film comprises any one or more of the metals disclosed herein.

Some embodiments relate to precursor compositions and related methods. The precursor compositions disclosed herein comprise nitrosyl precursors. In some embodiments, a nitrosyl precursor comprises a nitrosyl-containing compound. The precursor compositions may be applied for forming films useful in the fabrication of microelectronic devices, including semiconductor devices. In some embodiments, the precursor compositions comprise volatile Group VI nitrosyl precursors. In some embodiments, the volatile Group VI nitrosyl precursors are useful for depositing Group VI zero-valent films on substrates via vapor deposition processes. For example, in some embodiments, the precursor compositions are useful for forming molybdenum films and/or tungsten films. In some embodiments, the precursor compositions have a high purity such that resulting films have low levels of impurities.

The films may also be formed according to the methods disclosed herein. That is, the films disclosed herein may be formed by one or more deposition processes that utilize the precursor compositions. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

Some embodiments relate to a precursor composition. In some embodiments, the precursor composition comprises a precursor compound. In some embodiments, the precursor compound is a compound of the formula:

[(L¹)ₙM(L²)ₘ₋ₙ]_{z},
where:
L¹ is a first ligand;
M is a metal;
L² is a second ligand;
n is 1 to 6;
m is an oxidation state of M; and
z is 1 or 2.

In some embodiments, L¹ comprises an unsubstituted cyclopentadienyl ligand. In some embodiments, L¹ comprises a cyclopentadienyl ligand substituted with at least one methyl. In some embodiments, L¹ comprises a cyclopentadienyl ligand substituted with at least one ethyl. In some embodiments, L¹ comprises a cyclopentadienyl ligand substituted with at least one n-propyl. In some embodiments, L¹ comprises a cyclopentadienyl ligand substituted with at least one iso-propyl. In some embodiments, L¹ comprises at least one of an unsubstituted cyclopentadienyl ligand, a cyclopentadienyl ligand substituted with at least one methyl, a cyclopentadienyl ligand substituted with at least one ethyl, a cyclopentadienyl ligand substituted with at least one n-propyl, a cyclopentadienyl ligand substituted with at least one iso-propyl, or any combination thereof. In some embodiments, L¹ comprises an unsubstituted cyclopentadienyl ligand, or a cyclopentadienyl ligand substituted with at least one of a methyl, an ethyl, an n-propyl, or an iso-propyl.

In some embodiments, L¹ are each independently at least one of an unsubstituted cyclopentadienyl ligand, a cyclopentadienyl ligand substituted with at least one methyl, a cyclopentadienyl ligand substituted with at least one ethyl, a cyclopentadienyl ligand substituted with at least one n-propyl, a cyclopentadienyl ligand substituted with at least one iso-propyl, or any combination thereof. In some embodiments, L¹ are each independently an unsubstituted cyclopentadienyl ligand, or a cyclopentadienyl ligand substituted with at least one of a methyl, an ethyl, an n-propyl, or an iso-propyl. In some embodiments, at least two L¹ are different. In some embodiments, at least two L¹ are same.

In some embodiments, M is tungsten (W). In some embodiments, for example, M is W²⁺. In some embodiments, M is W³⁺. In some embodiments, M is W⁴⁺. In some embodiments, M is W⁵⁺. In some embodiments, M is W⁶⁺. In some embodiments, M is molybdenum (Mo). In some embodiments, for example, M is Mo²⁺. In some embodiments, M is Mo³⁺. In some embodiments, M is Mo⁴⁺. In some embodiments, M is Mo⁵⁺. In some embodiments, M is Mo⁶⁺.

In some embodiments, L² comprises a hydrogen. In some embodiments, L² comprises an alkyl. In some embodiments, L² comprises an alkyl. In some embodiments, L² comprises a nitrosyl. In some embodiments, L² comprises a carbonyl. In some embodiments, L² comprises a halide. In some embodiments, L² comprises at least one of a hydrogen, an alkyl, a nitrosyl, a carbonyl, a halide, or any combination thereof. In some embodiments, L² are each independently a hydrogen, an alkyl, a nitrosyl, a carbonyl, or a halide. In some embodiments, at least two L² are different. In some embodiments, at least two L² are same.

In some embodiments, when m−n=3, L² are each a carbonyl, a carbonyl, and a nitrosyl. In some embodiments, when m−n=3, L² are each a nitrosyl, a halide, and a halide. In some embodiments, when m−n=3, L² are each a halide, a halide, and at least one of a hydrogen, an alkyl, or any combination thereof. In some embodiments, when m−n=3, L² are each a halide, a halide, and at least one of a hydrogen, a methyl, an ethyl, an n-propyl, an isopropyl, or any combination thereof. In some embodiments, when m−n=4, L² are each a carbonyl, a carbonyl, a carbonyl, and at least one of a hydrogen, a methyl, an ethyl, an n-propyl, an isopropyl, or any combination thereof.

In some embodiments, n is 1. In some embodiments, n is 2. In some embodiments, n is 3. In some embodiments, n is 4. In some embodiments, n is 5. In some embodiments, n is 6. In some embodiments, m is 2. In some embodiments, m is 3. In some embodiments, m is 4. In some embodiments, m is 5. In some embodiments, m is 6. In some embodiments, z is 1. In some embodiments, z is 2.

In some embodiments, m is 2, n is 1, and z is 1.

In some embodiments, m is 3, n is 2, and z is 1. In some embodiments, m is 3, n is 1, and z is 1.

In some embodiments, m is 4, n is 3, and z is 1. In some embodiments, m is 4, n is 2, and z is 1. In some embodiments, m is 4, n is 1, and z is 1.

In some embodiments, m is 5, n is 4, and z is 1. In some embodiments, m is 5, n is 3, and z is 1. In some embodiments, m is 5, n is 2, and z is 1. In some embodiments, m is 5, n is 1, and z is 1.

In some embodiments, m is 6, n is 5, and z is 1. In some embodiments, m is 6, n is 4, and z is 1. In some embodiments, m is 6, n is 3, and z is 1. In some embodiments, m is 6, n is 2, and z is 1. In some embodiments, m is 6, n is 1, and z is 1.

In some embodiments, m is 2, n is 1, and z is 2.

In some embodiments, m is 3, n is 2, and z is 2. In some embodiments, m is 3, n is 1, and z is 2.

In some embodiments, m is 4, n is 3, and z is 2. In some embodiments, m is 4, n is 2, and z is 2. In some embodiments, m is 4, n is 1, and z is 2.

In some embodiments, m is 5, n is 4, and z is 2. In some embodiments, m is 5, n is 3, and z is 2. In some embodiments, m is 5, n is 2, and z is 2. In some embodiments, m is 5, n is 1, and z is 2.

In some embodiments, m is 6, n is 5, and z is 2. In some embodiments, m is 6, n is 4, and z is 2. In some embodiments, m is 6, n is 3, and z is 2. In some embodiments, m is 6, n is 2, and z is 2. In some embodiments, m is 6, n is 1, and z is 2.

In some embodiments, L¹ each independently comprise a cyclopentadienyl ligand; and L² each independently comprise at least one of a hydrogen, an alkyl, a nitrosyl, a carbonyl, a halide, or any combination thereof. In some embodiments, the cyclopentadienyl ligand is a ligand of the formula:

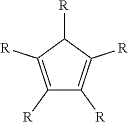

where:
R are each independently a hydrogen or a C₁-C₆ alkyl.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a hydrogen, an alkyl, a nitrosyl, a carbonyl, a halide, or any combination thereof.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a carbonyl, a nitrosyl, or any combination thereof.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a hydrogen, a carbonyl, a methyl, an ethyl, an n-propyl, an isopropyl, or any combination thereof.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a nitrosyl, a halide, or any combination thereof.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a hydrogen, a methyl, an ethyl, an n-propyl, an isopropyl, a halide, or any combination thereof.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a nitrosyl, a halide, or any combination thereof.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a hydrogen, a nitrosyl, a C₁-C₅ alkyl, an amine, an alkoxide, or any combination thereof.

In some embodiments, L¹ each independently comprise at least one of an unsubstituted cyclopentadienyl ligand, a substituted cyclopentadienyl ligand, or any combination thereof, wherein the substituted cyclopentadienyl ligand is substituted with at least one of a methyl, an ethyl, an n-propyl, an iso-propyl, or any combination thereof; and L² each independently comprise at least one of a hydrogen, a C₁-C₅ alkyl, an amine, an alkoxide, or any combination thereof.

In some embodiments, n is 1; m is 4; z is 1; M is Mo or W; L¹ is a cyclopentadienyl ligand; and L² are each independently a hydrogen, an alkyl, a nitrosyl, a carbonyl, or a halide.

In some embodiments, the cyclopentadienyl ligand is a ligand of the formula:

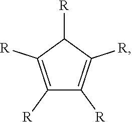

where:
R are each independently a hydrogen or a C₁-C₆ alkyl.

In some embodiments, wherein: n is 1; m is 4; z is 1; M is Mo or W; L¹ is an unsubstituted cyclopentadienyl ligand, or a cyclopentadienyl ligand substituted with at least one of a methyl, an ethyl, an n-propyl, or an iso-propyl; and (L²)₃ is (CO)₂NO.

In some embodiments, n is 1; m is 5; z is 1; M is Mo or W; L¹ is an unsubstituted cyclopentadienyl ligand, or a cyclopentadienyl ligand substituted with at least one of a methyl, an ethyl, an n-propyl, or an iso-propyl; and (L²)₄ is (CO)₃R², where R² is a hydrogen, a methyl, an ethyl, an n-propyl, or an isopropyl.

In some embodiments, n is 1; m is 4; z is 1; M is Mo or W; L¹ is an unsubstituted cyclopentadienyl ligand, or a cyclopentadienyl ligand substituted with at least one of a methyl, an ethyl, an n-propyl, or an iso-propyl; and (L²)₃ is NO(X)₂, where X is a halide.

In some embodiments, n is 1; m is 4; z is 1; M is Mo or W; L¹ is an unsubstituted cyclopentadienyl ligand, or a cyclopentadienyl ligand substituted with at least one of a methyl, an ethyl, an n-propyl, or an iso-propyl; and (L²)₃ is R²(X)₂, where R² is a hydrogen, a methyl, an ethyl, an n-propyl, or an isopropyl.

In some embodiments, n is 1; m is 4; z is 2; M is Mo or W; L¹ is an unsubstituted cyclopentadienyl ligand, or a cyclopentadienyl ligand substituted with at least one of a methyl, an ethyl, an n-propyl, or an iso-propyl; and (L²)₃ is NO(X)₂, where X is a halide.

In some embodiments, n is 1; m is 4; z is 2; M is Mo or W; L¹ is an unsubstituted cyclopentadienyl ligand, or a cyclopentadienyl ligand substituted with at least one of a methyl, an ethyl, an n-propyl, or an iso-propyl; and (L²)₃ is R²(X)₂, where R² is a hydrogen, a methyl, an ethyl, an n-propyl, or an isopropyl.

In some embodiments, n is 1; m is 4; z is 2 or greater; M is Mo or W; L¹ is an unsubstituted cyclopentadienyl ligand, or a cyclopentadienyl ligand substituted with at least one of a methyl, an ethyl, an n-propyl, or an iso-propyl; and (L²)₃ is NO(R′)₂, where R′ are each independently a hydrogen, a C₁-C₅ alkyl, an amine, or an alkoxide. In some embodiments, (R′)₂ is (H)₂. In some embodiments, (R′)₂ is (N(CH₃)₂)₂. In some embodiments, (R′)₂ is (OCH₃)₂.

In some embodiments, n is 1; m is 4; z is 2 or greater; M is Mo or W; L¹ is an unsubstituted cyclopentadienyl ligand, or a cyclopentadienyl ligand substituted with at least one of a methyl, an ethyl, an n-propyl, or an iso-propyl; and (L²)₃ is R²(R′)₂, where R′ are each independently a hydrogen, a C₁-C₅ alkyl, an amine, or an alkoxide; and where R² is a hydrogen, a methyl, an ethyl, an n-propyl, or an isopropyl. In some embodiments, (R′)₂ is (H)₂. In some embodiments, (R′)₂ is (N(CH₃)₂)₂. In some embodiments, (R′)₂ is (OCH₃)₂.

In some embodiments, a purity of the precursor compound in the composition is at least 95%. In some embodiments, a purity of the precursor compound in the composition is at least 99%. In some embodiments, a purity of the precursor compound in the composition is at least 99.5%. In some embodiments, a purity of the precursor compound in the composition is at least 99.6%. In some embodiments, a purity of the precursor compound in the composition is at least 99.7%. In some embodiments, a purity of the precursor compound in the composition is at least 99.8%. In some embodiments, a purity of the precursor compound in the composition is at least 99.9%. In some embodiments, a purity of the precursor compound in the composition is at least 99.99%. In some embodiments, a purity of the precursor compound in the composition is at least 99.999%. In some embodiments, a purity of the precursor compound in the composition is at least 99.9999%. In some embodiments, a purity of the precursor compound in the composition is 95% to 99.9999%, 95% to 99.999%, 95% to 99.99%, 95% to 99.9%, 95% to 99%, 95% to 98%, 95% to 97%, 95% to 96%, 96% to 99.9999%, 97% to 99.9999%, 98% to 99.9999%, 99.1% to 99.9999%, 99.2% to 99.9999%, 99.3% to 99.9999%, 99.4% to 99.9999%, 99.5% to 99.9999%, 99.6% to 99.9999%, 99.7% to 99.9999%, 99.8% to 99.9999%, 99.9% to 99.9999%, 99.99% to 99.9999%, 99.999% to 99.9999%, or any range or subrange between 95% and 100%.

In some embodiments, the precursor composition comprises less than 0.5% by weight of impurities based on a total weight of the composition. In some embodiments, the precursor composition comprises less than 0.4% by weight of impurities based on a total weight of the composition. In some embodiments, the precursor composition comprises less than 0.3% by weight of impurities based on a total weight of the composition. In some embodiments, the precursor composition comprises less than 0.2% by weight of impurities based on a total weight of the composition. In some embodiments, the precursor composition comprises less than 0.1% by weight of impurities based on a total weight of the composition. In some embodiments, the precursor composition comprises 0.0001% to 0.5%, 0.0001% to 0.4%, 0.0001% to 0.3%, 0.0001% to 0.2%, 0.0001% to 0.1%, 0.0001% to 0.01%, 0.0001% to 0.001%, 0.001% to 0.5%, 0.01% to 0.5%, 0.1% to 0.5%, 0.2% to 0.5%, 0.3% to 0.5%, 0.4% to 0.5%, or any range or subrange between 0.0001% to 0.5%, by weight of impurities based on a total weight of the composition. In some embodiments, the impurities comprise at least one of a carbon-containing compound, a reaction byproduct, or any combination thereof.

In some embodiments, the precursor composition comprises a precursor compound of the formula Cp^{Me}M(CO)₂NO, where Cp is a cyclopentadienyl ligand and Me is methyl. In some embodiments, the precursor composition comprises a precursor compound of the formula Cp^{Et}M(CO)₂NO, where Cp is a cyclopentadienyl ligand and Et is ethyl. In some embodiments, the precursor composition comprises a precursor compound of the formula Cp^{iPr}M(CO)₂NO, where Cp is a cyclopentadienyl ligand and iPr is isopropyl. In some embodiments, M is Mo or W.

In some embodiments, the precursor composition comprises a precursor compound of the formula Cp^{Me}M (CO)₃R², where Cp is a cyclopentadienyl ligand and Me is methyl. In some embodiments, the precursor composition comprises a precursor compound of the formula Cp^{Et}M(CO)₃R², where Cp is a cyclopentadienyl ligand and Et is ethyl. In some embodiments, the precursor composition comprises a precursor compound of the formula Cp^{iPr}M(CO)₃R², where Cp is a cyclopentadienyl ligand and iPr is isopropyl. In some embodiments, M is Mo or W.

In some embodiments, the precursor composition comprises a precursor compound of the formula [Cp^{R}M(NO)X₂]ₙ, where Cp is a cyclopentadienyl ligand; R each independently comprise at least one a hydrogen, a methyl, an ethyl, an isopropyl, or any combination hereof; M is Mo or W; X are each independently a halide; and n is 1 to 6.

In some embodiments, the precursor composition comprises a precursor compound of the formula [Cp^{R}M(R²)X₂]ₙ, where Cp is a cyclopentadienyl ligand; R each independently comprise at least one a hydrogen, a methyl, an ethyl, an isopropyl, or any combination hereof; R² comprises at least one a hydrogen, a methyl, an ethyl, an isopropyl, or any combination thereof; X are each independently a halide; and n is 1 to 6.

In some embodiments, the precursor composition comprises a precursor compound of the formula [Cp^{R}M(NO)(R′)₂]ₙ, where Cp is a cyclopentadienyl ligand; R each independently comprise at least one of a hydrogen, a methyl, an ethyl, an isopropyl, or any combination thereof; M is Mo or W; R′ each independently comprise a hydrogen, a C₁-C₅ alkyl, NR₂, NR, or OR, where R each independently comprise at least one a hydrogen, a methyl, an ethyl, an isopropyl, or any combination hereof; and n is 1 to 6. In some embodiments, the precursor composition comprises a precursor compound of the formula [Cp^{R}M(NO)(H)₂]ₙ. In some embodiments, the precursor composition comprises a precursor compound of the formula [Cp^{R}M(NO)(N(CH₃)₂)₂]ₙ. In some embodiments, the precursor composition comprises a precursor compound of the formula [Cp^{R}M(NO)(OCH₃)₂]ₙ.

In some embodiments, the precursor composition comprises a precursor compound of the formula [Cp^{R}M(R²)(R′)₂]ₙ, where Cp is a cyclopentadienyl ligand; R each independently comprise at least one of a hydrogen, a methyl, an ethyl, an isopropyl, or any combination thereof; M is Mo or W; R² each independently comprise at least one a hydrogen, a methyl, an ethyl, an isopropyl, or any combination thereof; R′ each independently comprise a hydrogen, a C₁-C₅ alkyl, NR₂, NR, or OR, where R each independently comprise at least one a hydrogen, a methyl, an ethyl, an isopropyl, or any combination hereof; and n is 1 to 6. In some embodiments, the precursor composition comprises a precursor compound of the formula [Cp^{R}M(NO)(H)₂]ₙ. In some embodiments, the precursor composition comprises a precursor compound of the formula [Cp^{R}M(NO)(N(CH₃)₂)₂]ₙ. In some embodiments, the precursor composition comprises a precursor compound of the formula [Cp^{R}M(NO)(OCH₃)₂]ₙ.

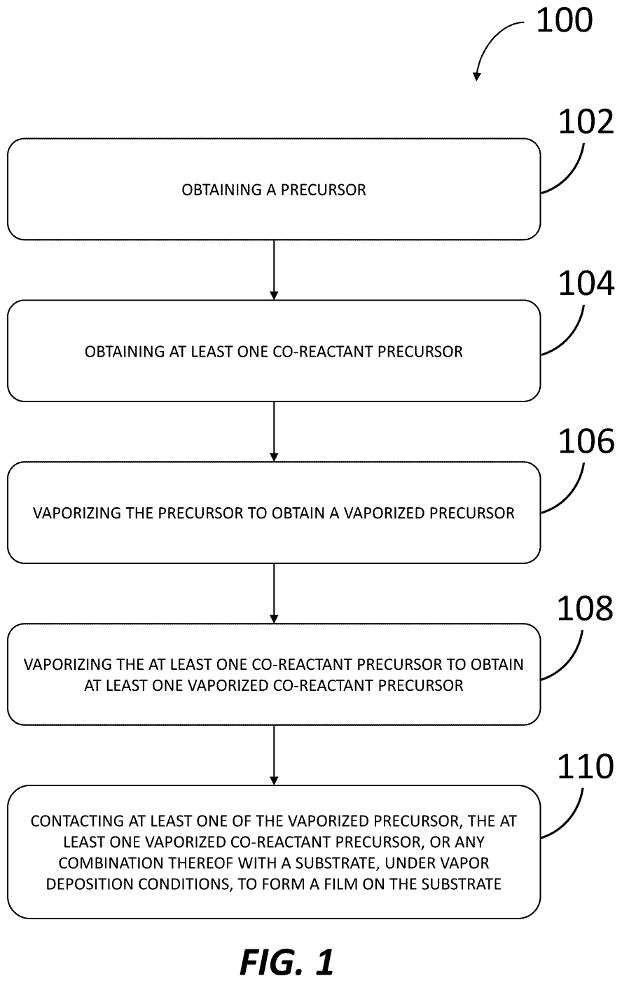

FIG. 1 is a flowchart of a method for making a film 100, according to some embodiments. As shown in FIG. 1, the method for making a film 100 may comprise one or more of the following steps: obtaining 102 a precursor, obtaining 104 at least one co-reactant precursor, vaporizing 106 the precursor to obtain a vaporized precursor, vaporizing 108 the at least one co-reactant precursor to obtain at least one vaporized co-reactant precursor, contacting 110 at least one of the vaporized precursor, the at least one vaporized co-reactant precursor, or any combination thereof with a substrate, under vapor deposition conditions, to form a film on the substrate.

The step 102 may comprise obtaining a precursor. The precursor may comprise any one or more of the precursors disclosed herein. The obtaining may comprise obtaining a container or other vessel comprising the precursor. In some embodiments, the precursor may be obtained in a container or other vessel in which the precursor is to be vaporized.

The step 104 may comprise obtaining at least one co-reactant precursor. In some embodiments, the at least one co-reactant precursor comprises, consists of, or consists essentially of, or is selected from the group consisting of, at least one of an oxidizing gas, a reducing gas, a hydrocarbon, or any combination thereof. The at least one co-reactant precursor may be selected to obtain a desired film. In some embodiments, the at least one co-reactant precursor may comprise at least one of N₂, H₂, NH₃, N₂H₄, CH₃HNNH₂, CH₃HNNHCH₃, NCH₃H₂, NCH₃CH₂H₂, N(CH₃)₂H, N(CH₃CH₂)₂H, N(CH₃)₃, N(CH₃CH₂)₃, Si(CH₃)₂NH, pyrazoline, pyridine, ethylene diamine, or any combination thereof. In some embodiments, the at least one co-reactant precursor may comprise at least one of H₂, O₂, O₃, H₂O, H₂O₂, NO, N₂O, NO₂, CO, CO₂, a carboxylic acid, an alcohol, a diol, or any combination thereof. In some embodiments, the at least one co-reactant precursor comprise at least one of methane, ethane, ethylene, acetylene, or any combination thereof. The obtaining may comprise obtaining a container or other vessel comprising the at least one co-reactant precursor. In some embodiments, the at least one co-reactant precursor may be obtained in a container or other vessel in which the at least one co-reactant precursor is to be vaporized. In some embodiments, the method further comprises an inert gas, such as, for example, at least one of argon, helium, nitrogen, or any combination thereof.

The step 106 may comprise vaporizing the precursor to obtain a vaporized precursor. The vaporizing may comprise heating the precursor sufficient to obtain the vaporized precursor. In some embodiments, the vaporizing may comprise heating a container comprising the precursor. In some embodiments, the vaporizing may comprise heating the precursor in a deposition chamber in which the vapor deposition process is performed. In some embodiments, the vaporizing may comprise heating a conduit for delivering the precursor, vaporized precursor, or any combination thereof to, for example, a deposition chamber. In some embodiments, the vaporizing may comprise operating a vapor delivery system comprising the precursor. In some embodiments, the vaporizing may comprise heating to a temperature sufficient to vaporize the precursor to obtain the vaporized precursor. In some embodiments, the vaporizing may comprise heating to a temperature below a decomposition temperature of at least one of the precursor, the vaporized precursor, or any combination thereof. In some embodiments, the precursor may be present in a gas phase, in which case the step 106 is optional and not required. For example, the precursor may comprise the vaporized precursor.

The step 108 may comprise vaporizing the at least one co-reactant precursor to obtain the at least one vaporized co-reactant precursor. In some embodiments, the vaporizing may comprise heating the at least one co-reactant precursor sufficient to obtain the at least one vaporized co-reactant precursor. In some embodiments, the vaporizing may comprise heating a container comprising the at least one co-reactant precursor. In some embodiments, the vaporizing may comprise heating the at least one co-reactant precursor in a deposition chamber in which the vapor deposition process is performed. In some embodiments, the vaporizing may comprise heating a conduit for delivering the at least one co-reactant precursor, the at least one vaporized co-reactant precursor, or any combination thereof to, for example, a deposition chamber. In some embodiments, the vaporizing may comprise operating a vapor delivery system comprising the at least one co-reactant precursor. In some embodiments, the vaporizing may comprise heating to a temperature sufficient to vaporize the at least one co-reactant precursor to obtain the at least one vaporized co-reactant precursor. In some embodiments, the vaporizing may comprise heating to a temperature below a decomposition temperature of at least one of the at least one co-reactant precursor, the at least one vaporized co-reactant precursor, or any combination thereof. In some embodiments, the at least one co-reactant precursor may be present in a gas phase, in which case the step 108 is optional and not required. For example, the at least one co-reactant precursor may comprise the at least one vaporized co-reactant precursor.

The step 110 may comprise contacting at least one of the vaporized precursor, the at least one vaporized co-reactant precursor, or any combination thereof, with the substrate, under vapor deposition conditions, sufficient to form a film on a surface of the substrate. The contacting may be performed in any system, apparatus, device, assembly, chamber thereof, or component thereof suitable for vapor deposition processes, including, for example and without limitation, a deposition chamber, among others. The vaporized precursor and the at least one co-reactant precursor may be contacted with the substrate at the same time or at different times. For example, each of the vaporized precursor, the at least one vaporized co-reactant precursor, and the substrate may be present in the deposition chamber at the same time. That is, in some embodiments, the contacting may comprise contemporaneous contacting or simultaneous contacting of the vaporized precursor and the at least one vaporized co-reactant precursor with the substrate. Alternatively, each of the vaporized precursor and the at least one vaporized co-reactant precursor may be present in the deposition chamber at different times. That is, in some embodiments, the contacting may comprise alternate and/or sequential contacting, in one or more cycles, of the vaporized precursor with the substrate and subsequently contacting the at least one vaporized co-reactant precursor with the substrate.

The vapor deposition conditions may comprise conditions for vapor deposition processes. Examples of vapor deposition conditions include, without limitation, vapor deposition conditions for vapor deposition processes including at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

The vapor deposition conditions may comprise a deposition temperature. The deposition temperature may be a temperature less than the thermal decomposition temperature of at least one of the vaporized precursor, the at least one vaporized co-reactant precursor, or any combination thereof. The deposition temperature may be sufficiently high to reduce or avoid condensation of at least one of the vaporized precursor, the at least one vaporized co-reactant precursor, or any combination thereof. In some embodiments, the substrate may be heated to the deposition temperature. In some embodiments, the chamber or other vessel in which the substrate is contacted with the vaporized precursor and the at least one vaporized co-reactant precursor is heated to the deposition temperature. In some embodiments, at least one of the vaporized precursor, the at least one vaporized co-reactant precursor, or any combination thereof may be heated to the deposition temperature.

The deposition temperature may be a temperature of 200° C. to 2500° C. In some embodiments, the deposition temperature may be a temperature of 500° C. to 700° C. For example, in some embodiments, the deposition temperature may be a temperature of 500° C. to 680° C., 500° C. to 660° C., 500° C. to 640° C., 500° C. to 620° C., 500° C. to 600° C., 500° C. to 580° C., 500° C. to 560° C., 500° C. to 540° C., 500° C. to 520° C., 520° C. to 700° C., 540° C. to 700° C., 560° C. to 700° C., 580° C. to 700° C., 600° C. to 700° C., 620° C. to 700° C., 640° C. to 700° C., 660° C. to 700° C., or 680° C. to 700° C. In other embodiments, the deposition temperature may be a temperature of greater than 200° C. to 2500° C., such as, for example and without limitation, a temperature of 400° C. to 2000, 500° C. to 2000° C., 550° C. to 2400° C., 600° C. to 2400° C., 625° C. to 2400° C., 650° C. to 2400° C., 675° C. to 2400° C., 700° C. to 2400° C., 725° C. to 2400° C., 750° C. to 2400° C., 775° C. to 2400° C., 800° C. to 2400° C., 825° C. to 2400° C., 850° C. to 2400° C., 875° C. to 2400° C., 900° C. to 2400° C., 925° C. to 2400° C., 950° C. to 2400° C., 975° C. to 2400° C., 1000° C. to 2400° C., 1025° C. to 2400° C., 1050° C. to 2400° C., 1075° C. to 2400° C., 1100° C. to 2400° C., 1200° C. to 2400° C., 1300° C. to 2400° C., 1400° C. to 2400° C., 1500° C. to 2400° C., 1600° C. to 2400° C., 1700° C. to 2400° C., 1800° C. to 2400° C., 1900° C. to 2400° C., 2000° C. to 2400° C., 2100° C. to 2400° C., 2200° C. to 2400° C., 2300° C. to 2400° C., 500° C. to 2000° C., 500° C. to 1900° C., 500° C. to 1800° C., 500° C. to 1700° C., 500° C. to 1600° C., 500° C. to 1500° C., 500° C. to 1400° C., 500° C. to 1300° C., 500° C. to 1200° C., 500° C. to 1100° C., 500° C. to 1000° C., 500° C. to 1000° C., 500° C. to 900° C., or 500° C. to 800° C.

The vapor deposition conditions may comprise a deposition pressure. In some embodiments, the deposition pressure may comprise a vapor pressure of at least one of the vaporized precursor, the at least one vaporized co-reactant precursor, or any combination thereof. In some embodiments, the deposition pressure may comprise a chamber pressure.

The deposition pressure may be a pressure of 0.001 Torr to 100 Torr. For example, in some embodiments, the deposition pressure may be a pressure of 1 Torr to 30 Torr, 1 Torr to 25 Torr, 1 Torr to 20 Torr, 1 Torr to 15 Torr, 1 Torr to 10 Torr, 5 Torr to 50 Torr, 5 Torr to 40 Torr, 5 Torr to 30 Torr, 5 Torr to 20 Torr, or 5 Torr to 15 Torr. In other embodiments, the deposition pressure may be a pressure of 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, 95 Torr to 100 Torr, 1 Torr to 95 Torr, 1 Torr to 90 Torr, 1 Torr to 85 Torr, 1 Torr to 80 Torr, 1 Torr to 75 Torr, or 1 Torr to 70 Torr. In other further embodiments, the deposition pressure may be a pressure of 1 mTorr to 100 mTorr, 1 mTorr to 90 mTorr, 1 mTorr to 80 mTorr, 1 mTorr to 70 mTorr, 1 mTorr to 60 mTorr, 1 mTorr to 50 m Torr, 1 mTorr to 40 mTorr, 1 mTorr to 30 mTorr, 1 mTorr to 20 mTorr, 1 mTorr to 10 mTorr, 100 mTorr to 300 mTorr, 150 mTorr to 300 mTorr, 200 mTorr to 300 mTorr, or 150 mTorr to 250 mTorr, or 150 mTorr to 225 mTorr.

The substrate may comprise at least one of Si, Co, Cu, AI, W, WN, WC, TiN, Mo, MoC, SiO₂, W, SiN, WCN, Al₂O₃, AlN, ZrO₂, La₂O₃, TaN, RuO₂, IrO₂, Nb₂O₃, Y₂O₃, hafnium oxide, or any combination thereof.

Some embodiments relate to a film on a surface of a substrate. In some embodiments, the film comprises any film formed according to the methods disclosed herein. In some embodiments, the film comprises any film prepared from the precursors disclosed herein. In some embodiments, the film comprises a tungsten-containing film. In some embodiments, the film comprises a molybdenum-containing film. In some embodiments, the film comprises a chromium-containing film.

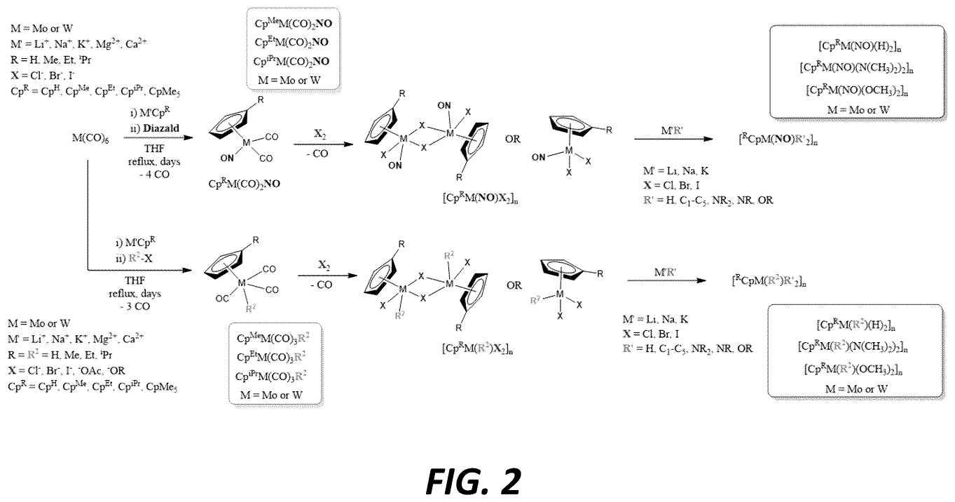

FIG. 2 is a schematic diagram illustrating a reaction scheme for preparing a precursor composition, according to some embodiments.

### Example 1

### Synthesis of CpMo(CO)₂(NO)

In a nitrogen-filled glovebox, Mo(CO)₆ (100 g, 370 mmol) was placed in a 3-neck 2 L roundbottom flask equipped with a magnetic stir bar, diluted with THF (500 mL), and placed under N₂ on the schlenk line. In a separate 1 L schlenk flask, NaCp (34.1 g, 388 mmol) was dissolved in THF (500 mL) and the subsequent pale yellow solution placed under N₂ on the Schlenk line and added to the Mo(CO)₆-containing solution over the course of one hour, the reaction flask equipped with a reflux condenser, and the resulting yellow mixture refluxed 60 hours. At this point the reaction presented as a pale-yellow solution, was cooled to room temperature, and the solvent was removed under reduced pressure to yield a pale-yellow solid. Unreacted Mo(CO)₆ was removed by heating the yellow solid at 90° C. under reduced pressure, whereby, the yellow solid was redissolved in THF (500 mL) to form a dark yellow solution. A Diazald solution (THF, 500 mL, 79.2 g, 370 mmol) was placed in a graduated addition funnel in the glovebox, adapted to the 2 L roundbottom flask, and added dropwise with stirring to the yellow solution over the course of one yellow, resulting in vigorous effervescence and gradual darkening. Upon complete addition the reaction mixture was stirred at room temperature for 12 hours, the solvent removed under reduced pressure to an orange-brown solid. The product was extracted with DCM (700 mL), filtered through a quick separation funnel column packed with acidified alumina under vacuum, and eluted as an orange solution. The volatiles were removed under reduced pressure to yield CpMo(CO)₂(NO) as a bright orange solid. Melting point: 84.6-85.8° C. (OptiMelt). Mass: 118.2 g, yield: 79.9%. 1H {¹³C}-NMR (400 MHZ, CDCl₃, 298K): 5.61 (s, 5H) ppm; ¹³C{¹H}-NMR (100 MHZ, CDCl₃, 298K): 93.60, 227.05 ppm.

### Example 2

### Synthesis of CpW(CO)₂(NO)

In a nitrogen-filled glovebox, W(CO)₆ (164.0 g, 468 mmol) was placed in a 3-neck 3 L flask equipped with a magnetic stir bar, glass stopper, and gas inlet adapter. Separately, NaCp (43.4 g, 492 mmol) was dissolved in THF (500 mL) and placed in a 1 L Schlenk flask. Both vessels were placed on the Schlenk line and put under N₂ atmosphere. Both the glass stoppers were replaced with a ¼″ PTFE transfer cannula and the NaCp solution transferred to the W(CO)₆ vessel with stirring over the course of one hour, at which point the cannula was replaced with a reflux condenser and the combined reagents refluxed for five days. At this point the reaction presented as a pale-yellow solution, was cooled to room temperature, and the volatiles removed under reduced pressure to yield a pale-yellow solid. Unreacted W(CO)₆ was removed by heating at 110° C. under reduced pressure, at which point the tungstate intermediate was dissolved in THF (500 mL) and a Diazald solution (THF, 500 mL, 97.6 g, 456 mmol) was added via cannula over the course of two hours, resulting in effervescence, gradual darkening, and presentation of a precipitate. Upon complete addition the reaction was stirred at room temperature for 12 hours, whereby the reaction presented as a dark reddish-brown mixture and the volatiles removed under reduced pressure to yield a dark brown solid. The product was extracted with DCM (600 mL), filtered through a 1.5″×8″ column packed with acidic alumina, and eluted as an orange band. Evaporation of the combined DCM solution yielded CpW(CO)₂(NO) as bright orange solid. Melting point: 107.8-109.1° C. (OptiMelt). Mass: 128.18 g, Yield: 82.0%. ¹H{¹³C}-NMR (400 MHZ, CDCl₃, 298K): 5.69 (s, 5H) ppm; ¹³C{¹H}-NMR (100 MHz, CDCl₃, 298K): 92.45, 217.50 ppm.

### Example 3

### Synthesis of MeCpMo(CO)₂(NO)

In a nitrogen-filled glovebox, Mo(CO)₆ (25.1 g, 93.2 mmol) was placed in a 250 mL 3-neck flask equipped with a magnetic stir bar and nitrogen inlet and diluted with THF (75 mL). NaCpMe (10.0 g, 97.9 mmol) was dissolved in THF (50 mL) and placed in a 200 mL air-free addition funnel. Both flasks were placed on the Schlenk line under N₂, the addition funnel adapted to the 3-neck flask, and the NaCpMe solution added to the Mo(CO)₆ mixture with stirring over the course of 45 minutes, resulting in effervescence and a darkening of the reaction mixture. Upon complete addition the funnel was replaced with a reflux condenser and the reaction mixture refluxed for 12 hours, at which point the resulting dark reddish-brown solution was cooled to room temperature and dried under reduced pressure to yield a reddish-brown solid. Unreacted Mo(CO)₆ was removed by heating at 90° C., at which point the reddish-brown solid was redissolved in THF (75 mL). A THF solution of Diazald (THF, 75 mL, 19.9 g, 93.2 mmol) was added to the reaction flask via addition funnel over the course of one hour, resulting in effervescence and a gradual change to an orange mixture. Upon complete addition the reaction mixture was stirred at room temperature for 12 hours, whereby, the volatiles were removed under reduced pressure and the resulting orange solid extracted with DCM (400 mL), filtering through a column packed with acidified alumina, and drying the reddish-orange solution under reduced pressure to yield MeCpMo(CO)₂(NO) as a red liquid. Mass: 21.16 g, 86.4% yield). The product may be distilled at a temperature of 50° C. and pressure of 30 mTorr. ¹H{¹³C}-NMR (400 MHZ, CDCl₃, 298K): 2.10 (s, 3H); 5.45 (d, 2H); 5.47 (d, 2H); ppm; ¹³C{¹H}-NMR (100 MHZ, CDCl₃, 298K): 14.11, 92.49, 92.79, 114.48, 227.67 ppm.

### Example 4

### Synthesis of ^{Me}CpW(CO)₂(NO)

In a nitrogen-filled glovebox, NaCpMe (10 g, 97.9 mmol) and W(CO)₆ (33.3 g, 93.2 mmol) were placed in a 500 mL 3-neck roundbottom flask equipped with stir bar and nitrogen inlet adapter and diluted with THF (250 mL) to yield a pale-yellow solution. The reaction mixture was brought out of the glovebox and placed under N₂ on the Schlenk line, equipped with a reflux condenser, and refluxed for five days. At this point the reaction presented as a dark amber solution, was cooled to room temperature, and the solvent removed under reduced to yield a pale-yellow solid. Unreacted W(CO)₆ was removed by heating the solid under reduced pressure at 110° C., whereby, the solid was redissolved in THF (250 mL) and the reaction flask outfitted with an addition funnel loaded with a THF solution of Diazald (150 mL, 19.9 g, 93.2 mmol). The Diazald solution was added dropwise with stirring over the course of 1.5 hours, resulting in effervescence, darkening, and formation of a precipitate. Upon complete addition the reaction mixture was stirred for 12 hours. At this point, the solvent was removed from the reddish-brown mixture to yield a dark brown solid, the product extracted with DCM (250 mL), filtered through a column packed with acidified alumina, and the orange eluent dried under reduced pressure to yield ^{Me}CpW(CO)₂(NO) as an orange solid. Mass: 12.45 g, 38.1% yield. Purity is 99.7% by 1H-NMR. Melting point: 32.2-33.7° C. (OptiMelt). ¹H{¹³C}-NMR (400 MHZ, CDCl₃, 298K): 2.22 (s, 3H); 5.53 (d, 2H); 5.55 (d, 2H) ppm; ¹³C{¹H}-NMR (100 MHZ, CDCl₃, 298K): 13.96, 91.04, 91.66, 112.78, 218.53 ppm.

### Example 5

### Synthesis of ^{Et}CpMo(CO)₂(NO)

In a nitrogen-filled glovebox, Mo(CO)₆ (2.0 g, 7.40 mmol) was placed in a 40 mL vial equipped with magnetic stir bar and diluted with THF (5 mL). Separately, KCp^{Et} (1.02 g, 7.77 mmol) was dissolved in THF (5 mL) and added to the Mo(CO)₆ mixture dropwise with stirring. Upon complete addition the resulting pale-yellow mixture was stirred at 65° C. for 36 hours, at which point the resulting yellow solution was cooled to room temperature and 5 mL of a THF solution of Diazald (1.58 g, 7.40 mmol) added dropwise with stirring over the course of five minutes, resulting in effervescence and presentation of an orange solution. Upon complete addition of Diazald the bright orange mixture was stirred for two hours, the solvent removed under reduced pressure to yield a reddish-orange mixture, the product extracted with DCM (10 mL), filtered through a plug of acidic alumina, and the solvent removed under reduced pressure to yield ^{Et}CpMo(CO)₂(NO) as a dark reddish-orange liquid. Mass: 0.90 g, Yield: 43.9%. ¹H{¹³C}-NMR (400 MHZ, CDCl₃, 298K): 1.15 (t, 3H); 2.42 (q, 2H); 5.43 (bm, 2H); 5.52 (bm, 2H) ppm; ¹³C{¹H}-NMR (100 MHz, CDCl₃, 298K): 15.27, 21.68, 91.82, 92.03, 121.56, 227.72 ppm.

### Example 6

### Synthesis of ^{Et}CpW(CO)₂(NO)

In a nitrogen-filled glovebox, W(CO)₆ (10.0 g, 27.9 mmol) was loaded into a 500 mL roundbottom Schlenk flask equipped with a magnetic stir bar and diluted with THF (50 mL). Separately, KCp^{Et} (3.86 g, 29.2 mmol) was dissolved in THF (50 mL) and loaded into a 200 mL air-free addition funnel. Both flasks were placed under N₂ on the Schlenk line and the KCp^{Et} solution added dropwise with stirring to the W(CO)₆ suspension with stirring over the course of 45 minutes, at which point, the addition funnel was replaced with a reflux condenser and the reaction mixture refluxed for five days. At this point, the reaction presented as an amber solution, was cooled to room temperature, and the solvent removed under reduced pressure to produce a light-yellow solid. Unreacted W(CO)₆ was removed by heating at 90° C. under reduced pressure, whereby, visible W(CO)₆ was collected at the top of the reaction flask. The reaction flask was cooled to room temperature and the Tungstate intermediate dissolved in THF (50 mL) to produce an amber solution. The reflux condenser was replaced with a 200 mL air-free addition funnel loaded with a 100 mL solution of Diazald (5.97 g, 27.9 mmol) which was added to the reaction flask dropwise over the course of one hour, resulting in effervescence and a gradual darkening of the solution. Upon complete addition of Diazald the resulting dark brown/red reaction mixture was covered with aluminum foil and stirred for 12 hours. At this point the reaction was filtered over a medium porosity glass-fritted funnel packed with celite, the filter cake washed with THF (2×50 mL) and pentane (1×50 ml), and the combined organics dried under reduced pressure to yield a black tacky solid. The product was extracted with DCM (150 mL) and filtered through a plug of acidified Al₂O₃ as an orange solution, whereby, evaporation of the solvent under reduced pressure yielded ^{Et}CpW(CO)₂(NO) as a light-orange liquid. Collected 3.0 g, yield: 29.7%, in >99% purity by NMR. ¹H{¹³C}-NMR (400 MHZ, CDCl₃, 298K): 1.17 (t, 3H); 2.52 (q, 2H); 5.52 (m, 2H); 5.59 (m, 2H) ppm; ¹³C{¹H}-NMR (100 MHZ, CDCl₃, 298K): 15.31, 21.63, 90.55, 90.83, 119.81, 218.48 ppm.

### ASPECTS

Aspect 1. A composition comprising:
a precursor compound of the formula:

[(L¹)ₙM(L²)ₘ₋ₙ]_{z},
where:
   L¹ is a first ligand;
   M is a metal;
   L² is a second ligand;
   n is 1 to 6;
   m is an oxidation state of M; and
   z is 1 or 2;
wherein a purity of the precursor compound in the composition is at least 99.5%.

Aspect 2. The composition according to Aspect 1,
wherein:
   n is 1;
   m is 4;
   z is 1;
   M is Mo or W;
   L¹ is a cyclopentadienyl ligand; and
   L² are each independently a hydrogen, an alkyl, a nitrosyl, a carbonyl, or a halide.

Aspect 3. The composition according to Aspect 2, wherein the cyclopentadienyl ligand is a ligand of the formula:

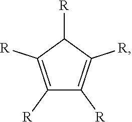

where:
   R are each independently a hydrogen or a C₁-C₆ alkyl.

Aspect 4. The composition according to Aspect 1,
wherein:
   n is 1;
   m is 4;
   z is 1;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₃ is (CO)₂NO.

Aspect 5. The composition according to Aspect 1,
wherein:
   n is 1;
   m is 5;
   z is 1;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₄ is (CO)₃R², where R² is a hydrogen, a methyl, an ethyl, an n-propyl, or an isopropyl.

Aspect 6. The composition according to Aspect 1,
wherein:
   n is 1;
   m is 4;
   z is 1;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₃ is NO(X)₂, where X is a halide.

Aspect 7. The composition according to Aspect 1,
wherein:
   n is 1;
   m is 4;
   z is 1;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₃ is R²(X)₂, where R² is a hydrogen, a methyl, an ethyl, an n-propyl, or an isopropyl.

Aspect 8. The composition according to Aspect 1,
wherein:
   n is 1;
   m is 4;
   z is 2;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₃ is NO(X)₂, where X is a halide.

Aspect 9. The composition according to Aspect 1,
wherein:
   n is 1;
   m is 4;
   z is 2;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₃ is R²(X)₂, where R² is a hydrogen, a methyl, an ethyl, an n-propyl, or an isopropyl.

Aspect 10. The composition according to Aspect 1,
wherein:
   n is 1;
   m is 4;
   z is 2 or greater;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₃ is NO(R′)₂, where R′ are each independently a hydrogen, a C₁-C₅ alkyl, an amine, or an alkoxide.

Aspect 11. The composition according to Aspect 10, wherein (R′)₂ is (H)₂.

Aspect 12. The composition according to Aspect 10, wherein (R′)₂ is (N(CH₃)₂)₂.

Aspect 13. The composition according to Aspect 10, wherein (R′)₂ is (OCH₃)₂.

Aspect 14. The composition according to Aspect 1,
wherein:
   n is 1;
   m is 4;
   z is 2 or greater;
   M is Mo or W;
   L¹ is an unsubstituted cyclopentadienyl ligand, or a cyclopentadienyl ligand substituted with at least one of a methyl, an ethyl, an n-propyl, or an iso-propyl; and
   (L²)₃ is R²(R′)₂, where R′ are each independently a hydrogen, a C₁-C₅ alkyl, an amine, or an alkoxide; and where R² is a hydrogen, a methyl, an ethyl, an n-propyl, or an isopropyl.

Aspect 15. The composition according to Aspect 14, wherein (R′)₂ is (H)₂.

Aspect 16. The composition according to Aspect 14, wherein (R′)₂ is (N(CH₃)₂)₂.

Aspect 17. The composition according to Aspect 14, wherein (R′)₂ is (OCH₃)₂.

Aspect 18. The composition according to any one of Aspects 1-17, wherein the purity of the precursor compound in the composition is at least 99.8%.

Aspect 19. The composition according to any one of Aspects 1-18, wherein the composition comprises less than 0.2% by weight of impurities based on a total weight of the composition.

Aspect 20. The composition according to Aspect 19, wherein the impurities comprise at least one of a carbon-containing compound, a reaction byproduct, or any combination thereof.

Various Aspects are described below. It is to be understood that any one or more of the features recited in the following Aspect(s) can be combined with any one or more other Aspect(s).

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A composition comprising:
a precursor compound of the formula:
[(L¹)ₙM(L²)ₘ₋ₙ]_{z},
where:
L¹ is a first ligand;
M is a metal;
L² is a second ligand;
n is 1 to 6;
m is an oxidation state of M; and
z is 1 or 2;
wherein a purity of the precursor compound in the composition is at least 99.5%.

2. The composition of claim 1,
wherein:
n is 1;
m is 4;
z is 1;
M is Mo or W;
L¹ is a cyclopentadienyl ligand; and
L² are each independently a hydrogen, an alkyl, a nitrosyl, a carbonyl, or a halide.

3. The composition of claim 2, wherein the cyclopentadienyl ligand is a ligand of the formula: 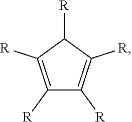
where:
R are each independently a hydrogen or a C₁-C₆ alkyl.

4. The composition of claim 1,
wherein:
n is 1;
m is 4;
z is 1;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₃ is (CO)₂NO.

5. The composition of claim 1,
wherein:
n is 1;
m is 5;
z is 1;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₄ is (CO)₃R², where R² is a hydrogen, a methyl, an ethyl, an n-propyl, or an isopropyl.

6. The composition of claim 1,
wherein:
n is 1;
m is 4;
z is 1;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₃ is NO(X)₂, where X is a halide.

7. The composition of claim 1,
wherein:
n is 1;
m is 4;
z is 1;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₃ is R²(X)₂, where R² is a hydrogen, a methyl, an ethyl, an n-propyl, or an isopropyl.

8. The composition of claim 1,
wherein:
n is 1;
m is 4;
z is 2;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₃ is NO(X)₂, where X is a halide.

9. The composition of claim 1,
wherein:
n is 1;
m is 4;
z is 2;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₃ is R²(X)₂, where R² is a hydrogen, a methyl, an ethyl, an n-propyl, or an isopropyl.

10. The composition of claim 1,
wherein:
n is 1;
m is 4;
z is 2 or greater;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₃ is NO(R′)₂, where R′ are each independently a hydrogen, a C₁-C₅ alkyl, an amine, or an alkoxide.

11. The composition of claim 10, wherein (R′)₂ is (H)₂.

12. The composition of claim 10, wherein (R′)₂ is (N(CH₃)₂)₂.

13. The composition of claim 10, wherein (R′)₂ is (OCH₃)₂.

14. The composition of claim 1,
wherein:
n is 1;
m is 4;
z is 2 or greater;
M is Mo or W;
L¹ is an unsubstituted cyclopentadienyl ligand, or a cyclopentadienyl ligand substituted with at least one of a methyl, an ethyl, an n-propyl, or an iso-propyl; and
(L²)₃ is R²(R′)₂, where R′ are each independently a hydrogen, a C₁-C₅ alkyl, an amine, or an alkoxide; and where R² is a hydrogen, a methyl, an ethyl, an n-propyl, or an isopropyl.

15. The composition of claim 14, wherein (R′)₂ is (H)₂.

16. The composition of claim 14, wherein (R′)₂ is (N(CH₃)₂)₂.

17. The composition of claim 14, wherein (R′)₂ is (OCH₃)₂.

18. The composition of claim 1, wherein the purity of the precursor compound in the composition is at least 99.8%.

19. The composition of claim 1, wherein the composition comprises less than 0.2% by weight of impurities based on a total weight of the composition.

20. The composition of claim 19, wherein the impurities comprise at least one of a carbon-containing compound, a reaction byproduct, or any combination thereof.
